(19) United States
(12) Patent Application Publication
(10) Pub. No.: US 2025/0163970 A1
(43) Pub. Date: May 22, 2025

(54) DAMPER DEVICE

(71) Applicant: EXEDY Corporation, Osaka (JP)

(72) Inventors: Naoya KOIZUMI, Osaka (JP); Hiroshi UEHARA, Osaka (JP)

(21) Appl. No.: 18/921,145

(22) Filed: Oct. 21, 2024

(30) Foreign Application Priority Data
Nov. 17, 2023 (JP) 2023-196075

(51) Int. Cl. F16D 3/12; F16D 7/02

(52) U.S. Cl. CPC F16D 3/12; F16D 7/025; F16D 2300/22

(57) ABSTRACT

In a damper device, a flange plate includes first and second lateral surfaces and an opening. An annularly expanded portion of a hub extends circumferentially on an outer peripheral surface of the hub body. The hub rotates with a flange plate. An intermediate member is disposed between the flange plate and a first plate. The intermediate member includes first and second inner wall surfaces. The first inner wall surface is opposed to the first lateral surface at an interval. The second inner wall surface is opposed to an outer peripheral surface of the annularly expanded portion at an interval. The first inner wall surface, the second inner wall surface, the first lateral surface, and the outer peripheral surface of the annularly expanded portion define a containing space having an annular shape. The configuration facilitates smooth operation.

### CROSS-REFERENCE TO RELATED APPLICATIONS

This application is based on and claims the priority benefit of Japanese application 2023-196075 filed on Nov. 17, 2023, the contents of which are incorporated herein by reference.

### TECHNICAL FIELD

The claimed invention relates to a damper device.

### BACKGROUND

Damper devices are configured to absorb and attenuate fluctuations in torque transmitted thereto from an internal combustion engine. For example, a damper device disclosed in Japan Laid-open Patent Application Publication No. 2021-196013 includes a first plate, a second plate, a hub flange, and elastic members. The elastic members elastically couple the hub flange and both the first and second plates.

It has been requested that a hub flange as described above be composed of separate members, namely, a hub and a flange. When the hub flange is thus composed of the hub and the flange as separate members, there is a concern that the structure of the hub flange might hinder the damper device from operating smoothly.

### SUMMARY OF THE INVENTION

It is an object of the claimed invention to provide a damper device capable of operating smoothly.

A damper device according to a first aspect includes a flange plate, a hub, a first plate, an elastic member, and an intermediate member. The flange plate includes a first lateral surface, a second lateral surface, and an opening. The first lateral surface faces a first side in an axial direction. The second lateral surface faces a second side in the axial direction. The opening is provided in a middle of the flange plate. The hub includes a body and an annularly expanded portion. The body extends in the axial direction. The annularly expanded portion extends on an outer peripheral surface of the body in a circumferential direction. The annularly expanded portion is press-fitted to the opening of the flange plate. The hub is configured to be unitarily rotated with the flange plate. The first plate is disposed away from the flange plate at an interval. The first plate is disposed on the first side of the flange plate in the axial direction. The elastic member elastically couples the flange plate and the first plate. The intermediate member is disposed between the flange plate and the first plate in the axial direction. The annularly expanded portion includes a third lateral surface facing the first side in the axial direction. The third lateral surface is located on the first side of the first lateral surface of the flange plate in the axial direction. The intermediate member includes a first inner wall surface and a second inner wall surface. The first inner wall surface is opposed to the first lateral surface at an interval. The second inner wall surface is opposed to an outer peripheral surface of the annularly expanded portion at an interval. The first inner wall surface, the second inner wall surface, the first lateral surface, and the outer peripheral surface of the annularly expanded portion define a containing space having an annular shape.

When a hub flange is composed of separate members, i.e., a hub and a flange plate, press-fitting the hub to the flange plate may be employed as a method of integrating the hub and the flange plate such that the hub and the flange plate can be unitarily rotated. In the hub flange thus formed, chances are that the hub is ground by the flange plate when press-fitted to the flange plate, whereby swarf is produced and is attached to the hub. If the swarf attached to the hub is detached in part therefrom in rotation of the damper device, there is a concern that the detached swarf can get stuck between respective members of the damper device, whereby the damper device is hindered from operating smoothly.

By contrast, in the damper device according to the first aspect, the containing space is defined by the first inner wall surface, the second inner wall surface, the first lateral surface, and the outer peripheral surface of the annularly expanded portion; hence, even if the swarf attached to the hub is detached therefrom, the detached swarf is confined in the containing space. As a result, the damper device is capable of operating smoothly.

A damper device according to a second aspect relates to the damper device according to the first aspect and is configured as follows. The third lateral surface is disposed away from the first inner wall surface at an interval in the axial direction.

A damper device according to a third aspect relates to the damper device according to the first or second aspect and is configured as follows. The annularly expanded portion includes swarf to be contained in the containing space.

Overall, according to the claimed invention, the damper device is capable of operating smoothly.

### BRIEF DESCRIPTION OF THE DRAWINGS

FIG. 1 is a front view of a damper device in accordance with the claimed invention.

FIG. 2 is a cross-sectional view of the damper device taken along angled cutlines II-II in FIG. 1.

FIG. 3 is an enlarged cross-sectional view of a portion of the damper device.

FIG. 4 is an enlarged cross-sectional view of a containing space and surrounding portions.

### DETAILED DESCRIPTION

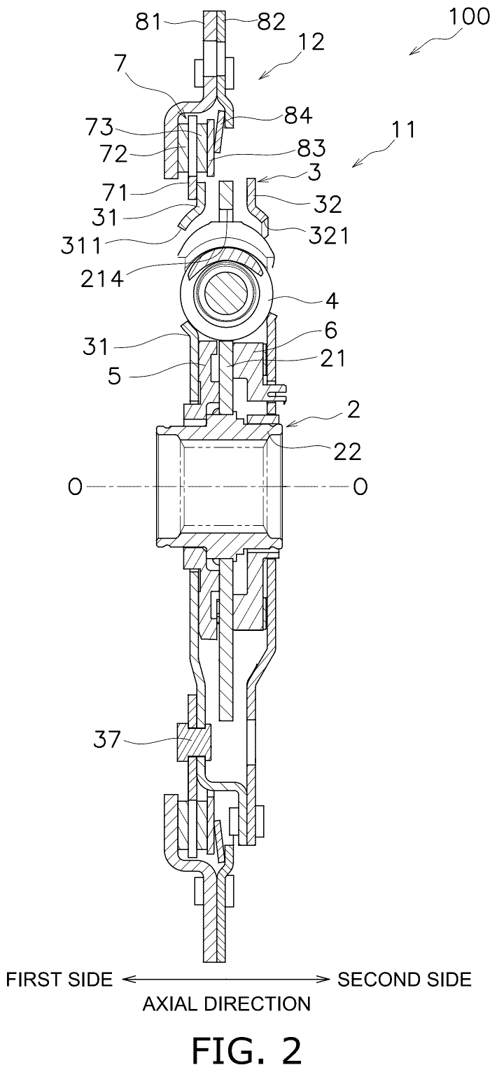

A damper device 100 according to the presently preferred embodiment will be hereinafter explained with reference to drawings. It should be noted that in the following explanation, the term “axial direction” refers to an extending direction of a rotational axis O of the damper device 100. On the other hand, the term “circumferential direction” refers to a circumferential direction of an imaginary circle about the rotational axis O, whereas the term “radial direction” refers to a radial direction of the imaginary circle about the rotational axis O. Furthermore, the term “first side in the axial direction” means the left side in FIG. 2, whereas the term “second side in the axial direction” means the right side in FIG. 2.

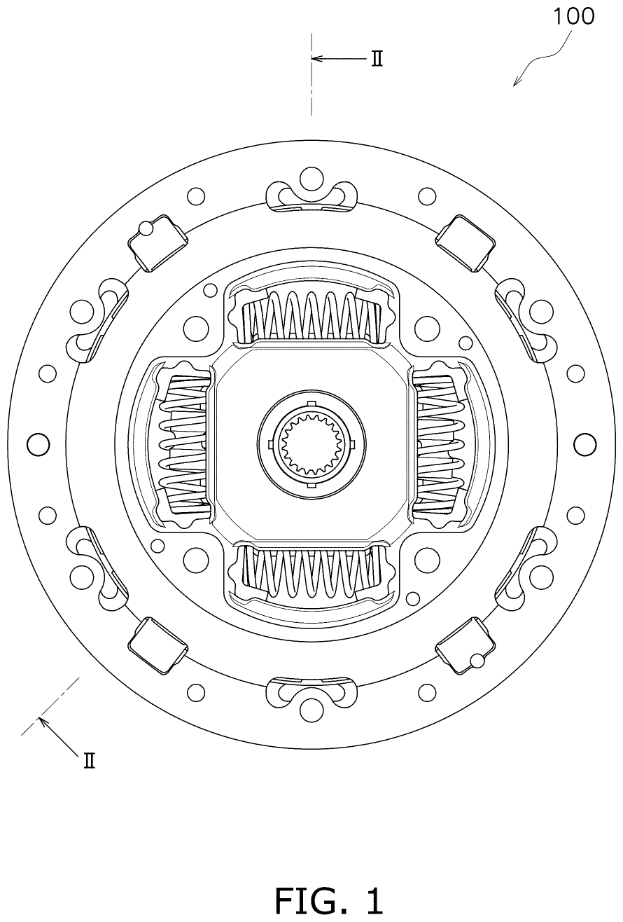

FIG. 1 is a front view of the damper device 100, whereas FIG. 2 is a cross-sectional view of the damper device 100 taken along angled cutlines II-II in FIG. 1. As shown in FIGS. 1 and 2, the damper device 100 includes a damper unit 11 and a torque limiter unit 12. Basically, the damper unit 11 and the torque limiter unit 12 are unitarily rotated with each other. The damper device 100 is installed between an internal combustion engine (omitted in illustration) and an output-side member (omitted in illustration). It should be noted that the output-side member may, for instance, be an electric motor, a transmission, and so forth. The damper device 100 is attached to a flywheel (omitted in illustration). For example, in FIG. 2, the internal combustion engine is disposed on the left side of the damper device 100, whereas the output-side member is disposed on the right side of the damper device 100. The damper device 100 is configured not only to limit torque transmitted between the internal combustion engine and the output-side member, but also to attenuate torque fluctuations.

### [Damper Unit]

The damper unit 11 is attached to the torque limiter unit 12. The damper unit 11 is configured to attenuate rotational fluctuations. The damper unit 11 includes an output rotor 2, an input rotor 3, elastic members 4, a first intermediate member 5 (exemplary intermediate member), a second intermediate member 6, and a friction disc 7.

### <Output Rotor>

The output rotor 2 is configured to transmit the torque, inputted thereto from the input rotor 3, to the output-side member. The output rotor 2 is disposed to be rotatable about the rotational axis O.

The output rotor 2 includes a flange plate 21 and a hub 22. The flange plate 21 and the hub 22 are configured to be unitarily rotated with each other.

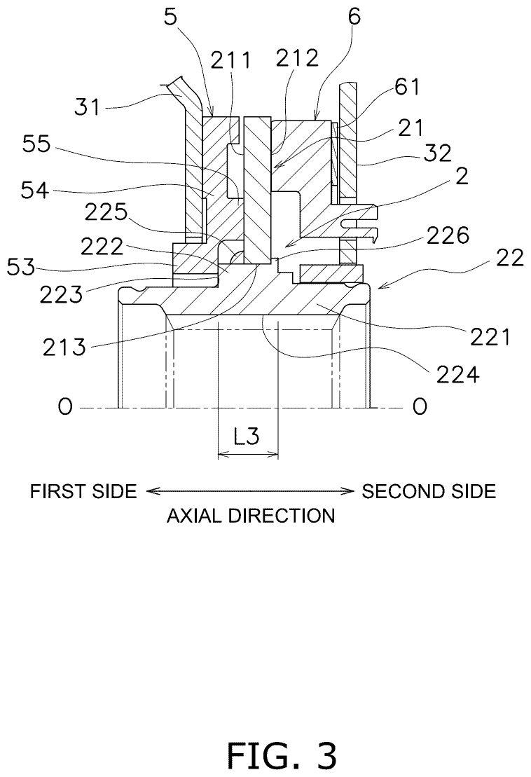

FIG. 3 is an enlarged cross-sectional view of the damper device 100. As shown in FIG. 3, the flange plate 21 includes a first lateral surface 211 and a second lateral surface 212. The first lateral surface 211 faces the first side in the axial direction. The second lateral surface 212 faces the second side in the axial direction.

The flange plate 21 includes an opening 213 in the middle part thereof. In other words, the flange plate 21 has an annular shape. Additionally, the flange plate 21 includes multiple accommodation holes 214. The accommodation holes 214 are spaced apart from each other at intervals in the circumferential direction. The accommodation holes 214 are configured to accommodate the elastic members 4, respectively.

The hub 22 includes a body 221 and an annularly expanded portion 222. The body 221 has a cylindrical shape. The body 221 extends in the axial direction. The body 221 penetrates an opening of a first plate 31 (to be described) and that of a second plate 32 (to be described) in the axial direction. The body 221 includes a spline hole 24 extending in the axial direction. The spline hole 224 enables an input shaft of the output-side member to be spline-coupled thereto.

The annularly expanded portion 222 is provided on the outer peripheral surface of the body 221. The annularly expanded portion 222 extends in the circumferential direction. The axial dimension of the annularly expanded portion 222 is larger than the thickness of the flange plate 21. For example, an attachment portion provided on the annularly expanded portion 222 has a dimension L3 that is about 1.5 to 3 times as large as the thickness of the flange plate 21.

The annularly expanded portion 222 is press-fitted to the opening 213 of the flange plate 21. Because of this, the hub 22 is unitarily rotated with the flange plate 21. In other words, the hub 22 is not rotated relative to the flange plate 21.

The annularly expanded portion 222 is press-fitted from an axially first-side portion thereof to the opening 213 of the flange plate 21. It should be noted that the annularly expanded portion 222 has an outer diameter slightly larger than the inner diameter of the opening 213 before it is press-fitted to the opening 213 of the flange plate 21. Additionally, the flange plate 21 has multiple teeth extending in the axial direction on the inner peripheral surface of the opening 213 thereof. Because of this, the annularly expanded portion 222 is ground by the flange plate 21 and produces swarf 225. The swarf 225 is attached to the annularly expanded portion 222. The swarf 225 is produced on the first side of the flange plate 21 in the axial direction. In other words, the swarf 225 is opposed to the first lateral surface 211 of the flange plate 21. The swarf 225 is opposed to the outer peripheral surface of the annularly expanded portion 222 as well.

The annularly expanded portion 222 includes a restriction protrusion 226. The restriction protrusion 226 protrudes radially outward from the outer peripheral surface of the annularly expanded portion 222. The restriction protrusion 226 extends in the circumferential direction. The restriction protrusion 226 is disposed on the second side of the flange plate 21 in the axial direction. The restriction protrusion 226 restricts the flange plate 21 from moving to the second side in the axial direction. The restriction protrusion 226 is formed after the annularly expanded portion 222 is press-fitted to the opening 213 of the flange plate 21. The restriction protrusion 226 may be formed, for instance, by swaging.

The annularly expanded portion 222 includes a third lateral surface 223. The third lateral surface 223 faces the first side in the axial direction. The flange plate 21 is disposed on an axially middle part of the annularly expanded portion 222. Because of this, the third lateral surface 223 of the annularly expanded portion 222 is located on the first side of the first lateral surface 211 of the flange plate 21 in the axial direction. It should be noted that the swarf 225 of the annularly expanded portion 222 is produced on a region between the first lateral surface 211 of the flange plate 21 and the third lateral surface 223 of the flange plate 21 on the outer peripheral surface of the annularly expanded portion 222.

### <Input Rotor>

As shown in FIG. 2, the input rotor 3 is disposed to be rotatable relative to the output rotor 2. The input rotor 3 includes the first and second plates 31 and 32. Each of the first and second plates 31 and 32 is an annular member including an opening in the center thereof. The body 221 of the hub 22 extends to penetrate the opening of the first plate 31 and that of the second plate 32. Not only the inner peripheral surface of the first plate 31 but also that of the second plate 32 is disposed radially away from the outer peripheral surface of the body 221 at an interval.

The first and second plates 31 and 32 are unitarily rotated with each other. Additionally, the first and second plates 31 and 32 are axially immovable relative to each other.

The first and second plates 31 and 32 are spaced apart from each other at an interval in the axial direction. The second plate 32 is disposed on the second side of the first plate 31 in the axial direction. The flange plate 21 is disposed axially between the first and second plates 31 and 32. The first and second plates 31 and 32 are disposed to be rotatable relative to the flange plate 21.

The first plate 31 is disposed on the first side of the flange plate 21 in the axial direction. The first plate 31 is disposed apart from the flange plate 21 at an interval in the axial direction. On the other hand, the second plate 32 is disposed on the second side of the flange plate 21 in the axial direction. The second plate 32 is disposed apart from the flange plate 21 at an interval in the axial direction.

The first plate 31 includes several window portions 311; likewise, the second plate 32 includes several window portions 321. The window portions 311 and the window portions 321 are, respectively, spaced apart from each other at intervals in the circumferential direction. The window portions 311 and the window portions 321 are configured to accommodate the elastic members 4, respectively. As axially seen, the window portions 311 and the window portions 321 are disposed to overlap with the accommodation holes 214, respectively.

### <Elastic Members>

The elastic members 4 are configured to elastically couple the input rotor 3 and the output rotor 2 in a rotational direction. In other words, the elastic members 4 elastically couple the flange plate 21 and the first plate 31 in the rotational direction. Additionally, the elastic members 4 elastically couple the flange plate 21 and the second plate 32 in the rotational direction. The elastic members 4 may, for instance, be coil springs.

The elastic members 4 are accommodated in the accommodation holes 214 of the flange plate 21, respectively. Additionally, the elastic members 4 are respectively accommodated in window portions 311 of the first plate 31 and window portions 321 of the second plate 32.

### <First Intermediate Member>

The first intermediate member 5 is disposed axially between the flange plate 21 and the first plate 31. The first intermediate member 5 has an annular shape and extends in the circumferential direction. The first intermediate member 5 is configured to be unitarily rotated with the flange plate 21. It should be noted that the first intermediate member 5 may be configured to rotate relative to the flange plate 21 within a predetermined range.

The first intermediate member 5 is disposed to be rotatable relative to the first plate 31. When the first intermediate member 5 is rotated relative to the first plate 31, a friction force is generated.

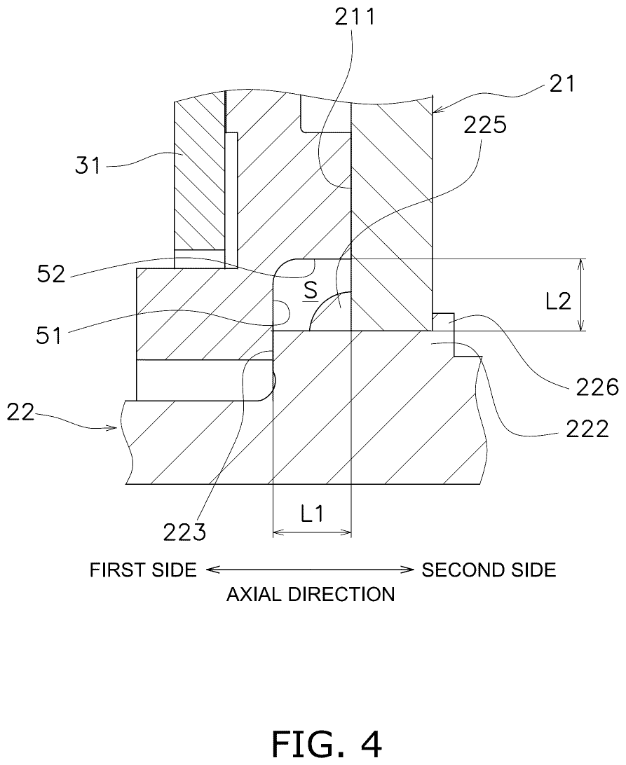

FIG. 4 is an enlarged cross-sectional view of a containing space S formed by the first intermediate member 5 and the periphery thereof. As shown in FIG. 4, the first intermediate member 5 includes a first inner wall surface 51 and a second inner wall surface 52. The first inner wall surface 51 is opposed to the first lateral surface 211 of the flange plate 21. In other words, the first inner wall surface 51 faces the second side in the axial direction.

The first inner wall surface 51 is spaced apart from the first lateral surface 211 at an interval in the axial direction. For example, distance L1, corresponding to the interval between the first inner wall surface 51 and the first lateral surface 211, may be from about 1.5 mm to about 4.0 mm. Additionally, the first inner wall surface 51 is disposed away from the third lateral surface 223 at an interval in the axial direction. For example, the interval between the first inner wall surface 51 and the third lateral surface 223 may be from about 0.05 mm to about 1.0 mm.

The first inner wall surface 51 extends in the circumferential direction. Additionally, the first inner wall surface 51 is disposed on the first side of the third lateral surface 223 of the annularly expanded portion 222 in the axial direction; alternatively, the first inner wall surface 51 is disposed to overlap with the third lateral surface 223 as seen in the axial direction.

The second inner wall surface 52 is opposed to the outer peripheral surface of the annularly expanded portion 222. In other words, the second inner wall surface 52 faces radially inward. The second inner wall surface 52 is spaced apart from the outer peripheral surface of the annularly expanded portion 222 at an interval. For example, distance L2, corresponding to the interval between the second inner wall surface 52 and the outer peripheral surface of the annularly expanded portion 222, may be about 1.5 mm to about 3.5 mm. The second inner wall surface 52 extends from the first inner wall surface 51 to the first lateral surface 211. The second inner wall surface 52 extends in the circumferential direction.

The first inner wall surface 51, the second inner wall surface 52, the first lateral surface 211, and the outer peripheral surface of the annularly expanded portion 222 define the containing space S having an annular shape. The containing space S is configured to contain the swarf 225 produced by press-fitting. The swarf 225 is thus confined in the containing space S; hence, the swarf 225, even if detached in part from the annularly expanded portion 222, does not get stuck between respective members of the damper device 100. Because of this, it is made possible to prevent the swarf 225 from hindering the damper device 100 from operating smoothly.

As shown in FIG. 3, the first intermediate member 5 includes a cylindrical portion 53, a disc portion 54, and a protruding portion 55. The cylindrical portion 53 extends in the axial direction. The cylindrical portion 53 is disposed on the outer peripheral surface of the body 221 of the hub 22. In other words, the inner peripheral surface of the cylindrical portion 53 is in contact with the outer peripheral surface of the body 221. It should be noted that the inner peripheral surface of the cylindrical portion 53, in part, is spaced apart from the outer peripheral surface of the body 221 at an interval. FIG. 3 shows a cross section of a region that the inner peripheral surface of the cylindrical portion 53 and the outer peripheral surface of the body 221 are spaced apart from each other at the interval.

The cylindrical portion 53 is disposed radially between the first plate 31 and the body 221. The cylindrical portion 53 extends to penetrate the opening of the first plate 31. A lateral surface of the cylindrical portion 53, facing the second side in the axial direction, is provided as the first inner wall surface 51.

The disc portion 54 extends radially outwardly from the axially second-side end of the cylindrical portion 53. The disc portion 54 is disposed axially between the first plate 31 and the flange plate 21. A lateral surface of the disc portion 54, facing the first side in the axial direction, is in contact with the first plate 31.

The protruding portion 55 protrudes from the disc portion 54 toward the flange plate 21 in the axial direction. In other words, the protruding portion 55 protrudes from the disc portion 54 to the second side in the axial direction. The protruding portion 55 is in contact with the flange plate 21. The protruding portion 55 has an annular shape and extends in the circumferential direction. The protruding portion 55 is disposed radially outside the cylindrical portion 53. The inner peripheral surface of the protruding portion 55 is provided as the second inner wall surface 52.

The second intermediate member 6 is disposed axially between the flange plate 21 and the second plate 32. The second intermediate member 6 has an annular shape and extends in the circumferential direction. The second intermediate member 6 is configured to be unitarily rotated with the second plate 32.

The second intermediate member 6 is disposed to be rotatable relative to the flange plate 21. A first disc spring 61 is disposed between the second intermediate member 6 and the second plate 32. The first disc spring 61 urges the second intermediate member 6 toward the flange plate 21 in the axial direction. When the second intermediate member 6 is rotated relative to the flange plate 21, a friction force is generated.

### <Friction Disc>

As shown in FIG. 2, the friction disc 7 is attached to the outer peripheral end of the input rotor 3. More particularly, the friction disc 7 is attached to the first plate 31 by fastening members 37. It should be noted that the friction disc 7 may be attached to the second plate 32. The friction disc 7 is unitarily rotated with the input rotor 3. It should be noted that the fastening members 37 may, for example, be rivets.

The friction disc 7 has an annular shape. The friction disc 7 includes a support plate 71, a first friction material 72, and a second friction material 73. The support plate 71, the first friction material 72, and the second friction material 73 are unitarily rotated with each other.

The support plate 71 is attached to the first plate 31. For example, the support plate 71 is attached to the first plate 31 by the fastening members 37. It should be noted that the support plate 71 is provided as a member separated from the first plate 31; alternatively, the support plate 71 may be integrated with the first plate 31 as a single member.

Each of the first and second friction materials 72 and 73 has an annular shape. The first friction material 72 is attached to one lateral surface of the support plate 71, whereas the second friction material 73 is attached to the other lateral surface of the support plate 71. The first and second friction materials 72 and 73 are unitarily rotated with the support plate 71.

When a torque having a magnitude that is greater than or equal to a predetermined value is inputted to the damper device 100, the friction disc 7 is rotated relative to a side plate 81 and a pressure plate 83, while being slid thereagainst through the first and second friction materials 72 and 73. On the other hand, when a torque having a magnitude that si less than the predetermined value is inputted to the damper device 100, the friction disc 7 is unitarily rotated with the side plate 81 and the pressure plate 83.

### [Torque Limiter Unit]

As shown in FIG. 2, the torque limiter unit 12 is disposed to be rotatable about the rotational axis O. The torque limiter unit 12 is disposed on the second side of the flywheel in the axial direction. The torque limiter unit 12 has an annular shape. The torque limiter unit 12 is attached to the flywheel.

The torque limiter unit 12 is configured to limit the torque transmitted between the flywheel and the damper unit 11. In other words, the torque limiter unit 12 is configured to restrict transmission of a torque in the damper device 100 when the torque has a magnitude greater than or equal to a predetermined value. The torque limiter unit 12 is configured to be engaged by friction with the friction disc 7. Additionally, the torque limiter unit 12 sandwiches the friction disc 7 therein in the axial direction.

The torque limiter unit 12 includes the side plate 81, a cover plate 82, the pressure plate 83, and a second disc spring 84.

The side plate 81 and the cover plate 82 are attached to the flywheel. The side plate 81 and the cover plate 82 are unitarily rotated with the flywheel. Each of the side plate 81 and the cover plate 82 has an annular shape. The cover plate 82 is disposed on the second side of the side plate 81 in the axial direction. The cover plate 82 is smaller in thickness than the side plate 81.

The pressure plate 83 has an annular shape. The pressure plate 83 is disposed axially between the side plate 81 and the cover plate 82. More particularly, the pressure plate 83 is disposed axially between the second friction material 73 and the second disc spring 84. The pressure plate 83 is configured to be unitarily rotated with the side plate 81. It should be noted that the pressure plate 83 is axially movable with respect to the side plate 81.

The second disc spring 84 is disposed axially between the cover plate 82 and the pressure plate 83. The second disc spring 84 urges the pressure plate 83 to the first side in the axial direction. In other words, the second disc spring 84 urges the pressure plate 83 toward the friction disc 7. Accordingly, the friction disc 7 is sandwiched by and between the pressure plate 83 and the side plate 81.

### [Modifications]

The claimed invention is not limited to the preferred embodiment described above, and a variety of changes or modifications can be made without departing from the scope of the claimed invention. Moreover, respective modifications to be described are applicable simultaneously.

(a) In the preferred embodiment described above, the damper device 100 includes the torque limiter unit 12; however, the damper device 100 is not limited in configuration to this. For example, the damper device 100 may not include the torque limiter unit 12.

(b) In the preferred embodiment described above, the damper device 100 includes the first and second plates 31 and 32 as the input rotor 3; however, the input rotor 3 is not limited in configuration to this. For example, the input rotor 3 may not include the second plate 32. In this case, the damper device 100 may not include the second intermediate member 6 as well.

(c) In the preferred embodiment described above, the first plate 31 composes in part the input rotor 3, whereas the flange plate 21 and the hub 22 compose the output rotor 2; however, the damper device 100 is not limited in configuration to this. For example, the first plate 31 may compose at least in part an output rotor, whereas the flange plate 21 and the hub 22 may compose an input rotor. In other words, a torque may be inputted to the damper device 100 from the flange plate 21 and the hub 22 and may be outputted therefrom through the first plate 31.

(d) In the preferred embodiment described above, the internal combustion engine is disposed on the first side of the damper device 100 in the axial direction, whereas the output-side member is disposed on the second side of the damper device 100 in the axial direction; however, arrangement of the internal combustion engine and the output-side member with respect to the damper device 100 is not limited to this. For example, the internal combustion engine may be disposed on the second side of the damper device 100 in the axial direction, whereas the output-side member may be disposed on the first side of the damper device 100 in the axial direction.

### LIST OF REFERENCE NUMERALS

4: Elastic member, 5: First intermediate member, 51: First inner wall surface, 52: Second inner wall surface, 21: Flange plate, 211: First lateral surface, 212: Second lateral surface, 213: Opening, 22: Hub, 221: Body, 222: Annularly expanded portion, 223: Third lateral surface, 31: First plate, 100: Damper device, S: Containing space

The invention claimed is:

1. A damper device, comprising:
a flange plate including a first lateral surface, a second lateral surface, and an opening, the first lateral surface facing a first side of the flange plate in an axial direction, the second lateral surface facing a second side of the flange plate in the axial direction, the opening provided in a middle of the flange plate;
a hub configured to be unitarily rotated with the flange plate, the hub including a body and an annularly expanded portion, the body extending in the axial direction, the annularly expanded portion extending on an outer peripheral surface of the body in a circumferential direction, the annularly expanded portion press-fitted to the opening of the flange plate;
a first plate spaced apart from the flange plate at an interval, the first plate disposed on the first side of the flange plate in the axial direction;
an elastic member elastically coupling the flange plate and the first plate; and
an intermediate member disposed between the flange plate and the first plate in the axial direction,
wherein the annularly expanded portion includes a third lateral surface facing the first side in the axial direction,
the third lateral surface is located on the first side of the first lateral surface of the flange plate in the axial direction,
the intermediate member includes a first inner wall surface and a second inner wall surface, the first inner wall surface being opposed to the first lateral surface at an interval, the second inner wall surface opposed to an outer peripheral surface of the annularly expanded portion at an interval, and
the first inner wall surface, the second inner wall surface, the first lateral surface, and the outer peripheral surface of the annularly expanded portion define a containing space having an annular shape.

2. The damper device according to claim 1, wherein the third lateral surface is disposed away from the first inner wall surface at an interval in the axial direction.

3. The damper device according to claim 1, wherein the annularly expanded portion includes swarf to be contained in the containing space.
